(19) United States
(12) Patent Application Publication
(10) Pub. No.: US 2012/0263026 A1
(43) Pub. Date: Oct. 18, 2012

(54) METHOD FOR DETERMINING ECCENTRICITY OF OPTICAL DISC

(75) Inventors: Ming-Hua Hsueh, Taoyuan County (TW); Yi-Long Hsiao, Taoyuan County (TW)

(73) Assignee: Quanta Storage Inc., Taoyuan County (TW)

(21) Appl. No.: 13/412,663

(22) Filed: Mar. 6, 2012

(30) Foreign Application Priority Data
Apr. 12, 2011 (TW) 100112740

(51) Int. Cl. G11B 7/00

(52) U.S. Cl. 369/53.11; G9B/7

(57) ABSTRACT

A method for determining an eccentricity of an optical disc is provided. The method includes predetermining a plurality of optical disc with known eccentric distances, respectively measuring a ratio of maximum and minimum amplitudes of a tracking error signal of the optical discs, establishing an eccentric distance ratio table or curve, measuring a ratio of maximum and minimum amplitudes of the tracking error signal for an optical disc under test, and comparing the measured ratio with the table or curve to promptly determine the eccentricity distance of the optical disc under test.

This application claims the benefit of Taiwan application Serial No. 100112740, filed Apr. 12, 2011, the subject matter of which is incorporated herein by reference.

### BACKGROUND OF THE INVENTION

1. Field of the Invention

The invention relates in general to a method for determining an eccentricity of an optical disc under test for an optical disc drive, and more particularly to a method for determining an eccentricity of an optical disc for adjusting control parameters of an optical disc drive.

2. Description of the Related Art

An eccentric optical disc being rotated with a high speed in an optical disc drive brings vigorous displaced vibrations, such that light beams projected from the optical disc drive to the optical disc may fail to form effective tracking error (TE) control signals. The TE signals are for controlling beam spots to focus at the optical disc and move along data tracks in order to correctly read data in the optical disc.

FIG. 1 shows a schematic diagram of a conventional method for determining an eccentricity of an optical disc. In FIG. 1, an optical disc 1 comprises a data side consisted of a plurality of data tracks 2 that appear as substantially concentric circles. Caused by possible unsatisfactory manufacturing control procedures of the optical disc 1, an eccentric optical disc 1 is much likely resulted. When the eccentric optical disc 1 is placed and rotated in the optical disc drive, the disc tracks 2 are not concentrically rotated as desired. Instead, as indicated by dotted lines, the data tracks 2 are displaced and rotated in ellipsoids. Consequently, a data read process of the optical disc drive according to the TE signals along the data tracks 2 becomes complicated and even infeasible due to excessively displaced revolutions. Thus, in order to allow the optical disc drive to read data, a rotational speed should be appropriated reduced according to the magnitude of eccentricity of the eccentric optical disc 1.

In general, the magnitude of displaced revolutions of the optical disc 1 increases as the eccentricity of the optical disc becomes larger. With reference to TW Patent No. 1304582 disclosing associated prior art, a pickup head is first provided at a fixed reference position R, and, through characteristics that a TE signal is generated when the pickup head crosses a data track, a count of TE signals that indicates the number of data tracks crossed by TE signals is computed. The count is multiplied by a track distance D of the data track 2 to obtain an eccentric distance of the optical disc to detect the eccentricity of the optical disc, and thus correspondingly adjust control parameters of the optical disc drive such as a rotational speed.

However, stable TE signals are difficult to get due to displaced vibrations during revolutions of an eccentric optical disc. In the prior art, the count of unstable TE signals serves as basis for calculating the eccentric distance of the optical disc, and so an eccentric distance obtained through such approach is rather questionable and is also unsuitable for subsequent adjustments on control parameters and reading/writing controls of the optical disc drive. Therefore, there is a need for an improved solution for determining the eccentricity of an optical disc to obviate the abovementioned problems associated with the prior art.

### SUMMARY OF THE INVENTION

It is an object of the present invention to provide a method for determining an eccentricity of an optical disc. Through a plurality of predetermined optical disc with known eccentric distances, a ratio between minimum and maximum amplitudes of TE signals is respectively measured to establish an eccentric distance table or curve.

It is another object of the present invention to provide a method for determining an eccentricity of an optical disc. A ratio between minimum and maximum amplitudes of TE signals of an optical disc under test is measured and compared with an established eccentric distance ratio table or curve to promptly determine an eccentric distance of the optical disc.

To achieve the above objects, the method for determining an eccentricity of an optical disc comprises predetermining a plurality of optical discs with known eccentric distances, respectively measuring a ratio between minimum and maximum amplitudes of TE signals of the predetermined optical discs to establish an eccentric distance ratio table or curve, measuring a ratio between eccentric ratio curve or table of a TE signal of an optical disc under test, and comparing the measured ratio with the eccentric distance ratio table or curve to obtain an eccentric distance of the optical disc under test.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a conventional method for determining the eccentricity of an optical disc.

FIG. 2 is a functional block diagram of an optical disc drive generating a track error (TE) signal.

FIG. 3 is a schematic diagram of a TE signal.

FIG. 4 is a schematic diagram an optimal projection angle of a normal optical disc.

FIG. 5 is a TE signal of a normal optical disc.

FIG. 6 is a schematic diagram of a change in the projection angle of an eccentric optical disc.

FIG. 7 is a schematic diagram of a TE signal of an eccentric optical disc.

FIG. 8 is an eccentric distance ratio table of the present invention.

FIG. 9 is an eccentric distance ratio curve of the present invention.

FIG. 10 is a flowchart of a method for determining an eccentricity of an optical disc of the present invention.

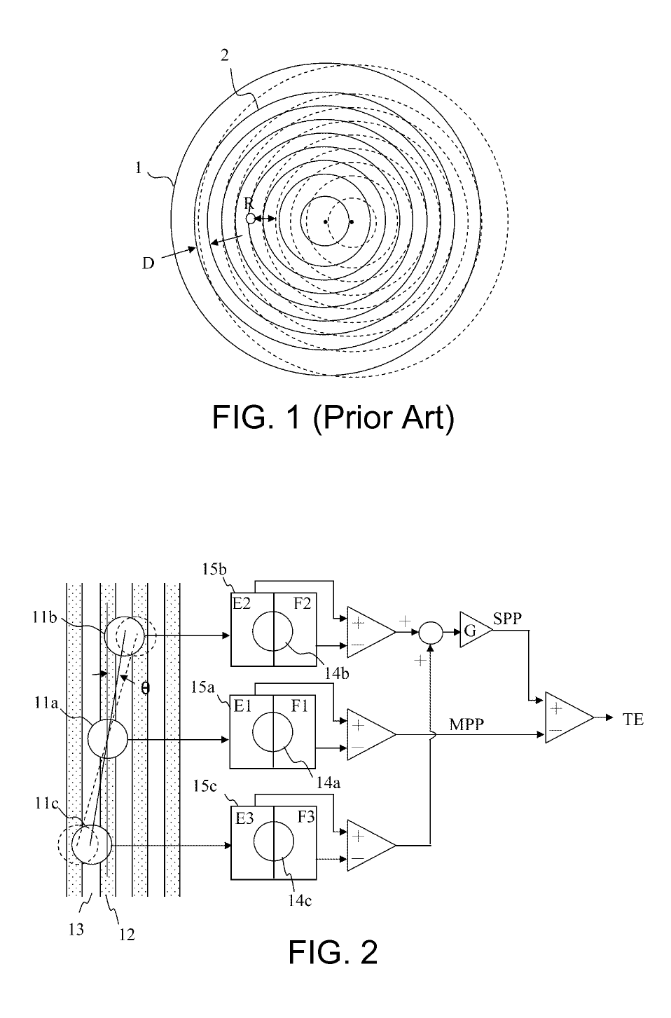

### DETAILED DESCRIPTION OF THE INVENTION

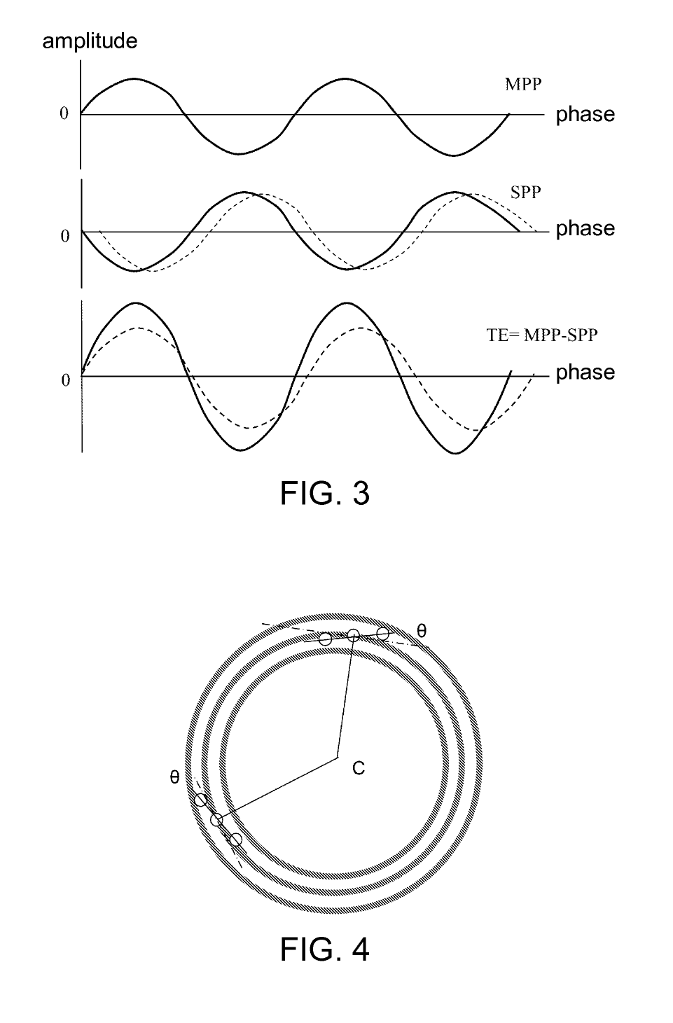

Referring to FIGS. 2 and 3, FIG. 2 shows a functional block diagram of an optical disc drive generating a TE signal, and FIG. 3 shows a schematic diagram of a TE signal. When the optical disc performs track control via differential push-pull (DPP), a pickup head focuses laser beams to a main light beam 11a and two secondary light beams 11b and 11c, which are respectively projected to a data groove 12 and two lands 13. The projected light beams are reflected by an optical disc into reflected beam spots 14a, 14b and 14c, which are then respectively projected to a main optical transducer 15a and two secondary optical transducers 15b and 15c. The optical transducers 15a, 15b and 15c are respectively divided into two same-sized sub-units E and F, and convert light flux at the reflected beam spots 14a, 14b and 14c into corresponding electric signals. The electric signal E1-F1 of two sub-units of the main optical transducer 15a forms a main push-pull (MPP) signal. The electric signals [(E2-F2)+(E3-F3)] of the two sub-units of the two secondary transducers 15b and 15c are adjusted by a gain G to a magnitude substantially the same as that of the MPP signal to form a secondary push-pull (SPP) signal. The SPP signal is subtracted from the MPP signal (MPP-SPP) to form the TE signal, which serves as a control signal for the tracking of the optical disc drive.

An optimal projection angle θ between the main and secondary beams projected from the pickup head and the data groove is generally designed to render a 180-degree phase difference between the MPP signal and the SPP signal, so that the TE signal formed by (MPP-SPP) is given a maximum value to obtain an ideal TE signal that facilitates the control of the main beam 11a along of data groove 12, thereby correctly reading marks in the data groove 12. However, when an angle between the main and secondary beams and the data groove is not the predetermined optimal angle θ, a phase difference between the MPP signal and the SPP signal is not the predetermined phase difference either. As indicated by a dotted line in FIG. 3, the phase difference between the MPP and SPP signals is not 180 degrees such that the TE signal formed by (MPP-SPP) is attenuated.

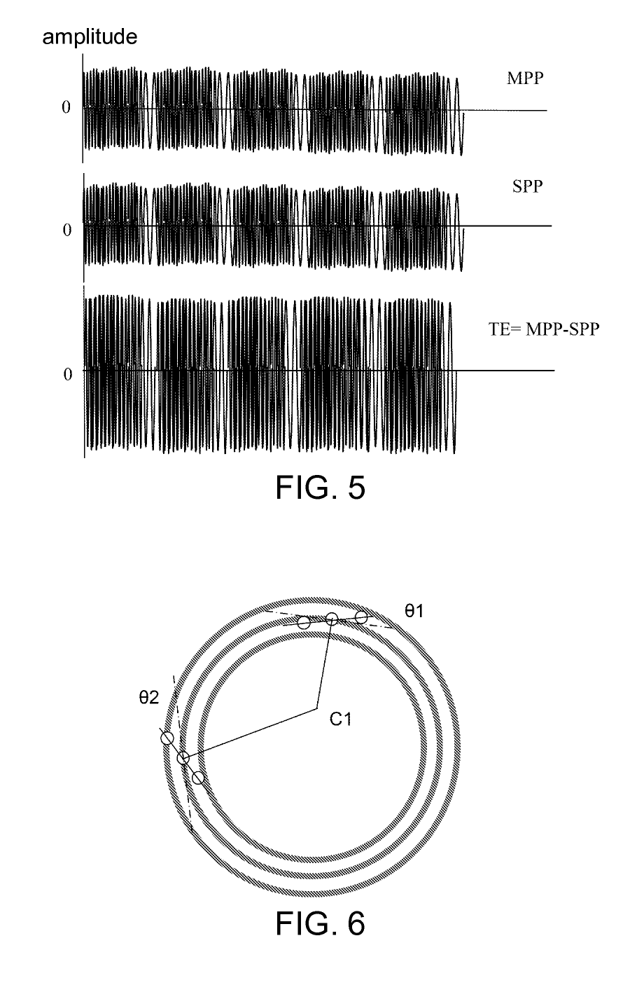

Referring to FIGS. 4 and 5, FIG. 4 shows an optimal projection angle of the normal optical disc, and FIG. 5 shows a TE signal of a normal optical disc. When a normal optical disc is rotated around a center C, an optimal angle θ is maintained between the main and secondary beams projected by the pickup head and the data groove. At this point, a phase difference between the MPP and SPP signals is 180 degrees, and hence the amplitudes of the MPP and SPP signals as well as the TE signal are kept substantially the same.

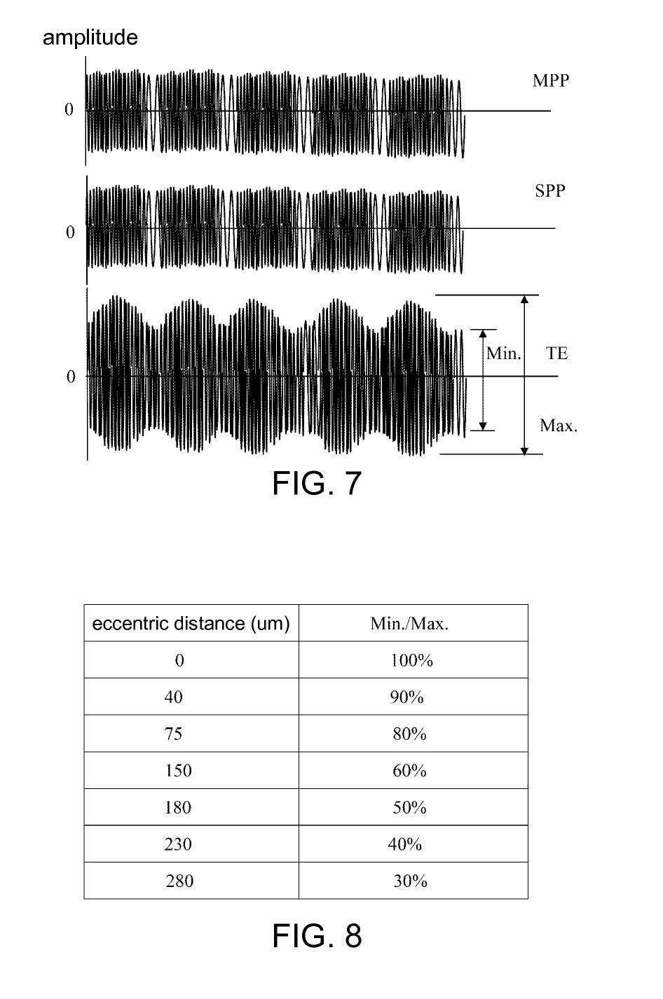

Referring to FIGS. 6 and 7, FIG. 6 illustrates a change in the projection angle of an eccentric optical disc, and FIG. 7 shows a TE signal of the eccentric optical disc. When the eccentric optical disc rotates around an eccentric center C1, projection angle changes such as θ1 and θ2 between the main and secondary beams projected by the pickup head and the data groove are resulted from the high-speed eccentric revolutions of the optical disc. Instead of maintaining the optimal projection angle, the angle between the main and secondary beams projected by the pickup head and the data groove changes back and forth. Meanwhile, since the phase difference between the MPP and SPP signals correspondingly fails to be kept at 180 degrees but varies by a range near 180 degrees, a fluctuated amplitude of the TE signal is formed.

In the present invention, it is discovered that, as the eccentric distance of the eccentric optical disc gets larger, a range near 180 degrees by which the phase difference between the MPP and SPP signals varies increases while the change in the amplitude of TE signal also becomes larger. Therefore, in the present invention, through a relationship of corresponding changes between the amplitude change of the TE signal and the eccentric distance of the eccentric optical disc, minimum and maximum amplitudes of the TE signal are directly measured, and a ratio between the minimum and the maximum is calculated accordingly to serve as the amplitude change of the TE signal. For a plurality of eccentric optical disc with known eccentric distances, the amplitude change of TE signals is measured, that is, a ratio between minimum and maximum amplitudes is calculated, and an eccentric distance ratio table shown in FIG. 8 is established accordingly and stored in the optical disc drive for future use. The ratio between the minimum and maximum amplitudes may be represented by a percentage.

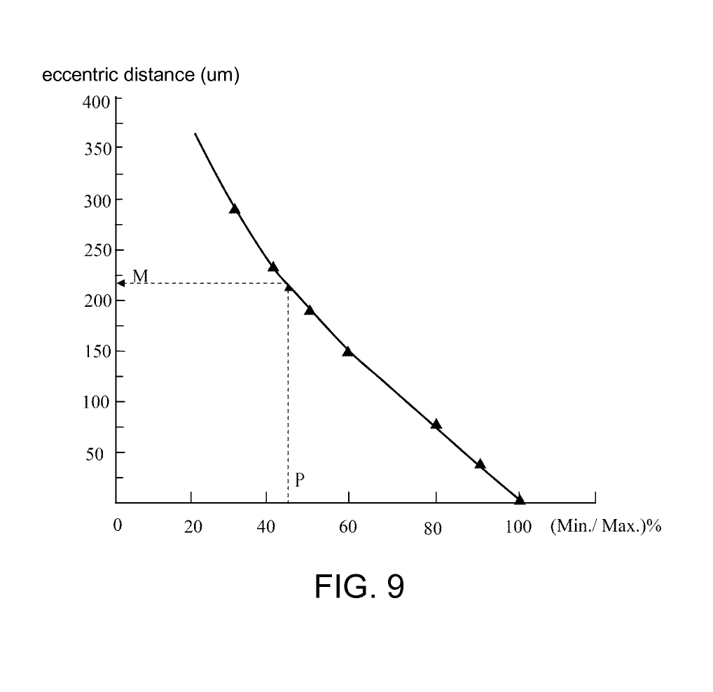

To determine an eccentric distance of an optical disc, an optical disc to be tested is placed into an optical disc drive and rotated, and the ratio between minimum and maximum amplitudes of the TE signal is measured. By referring to the eccentric distance ratio table in FIG. 8, the eccentric distance of the optical disc under test may be calculated through interpolation or extrapolation. To simplify the determination process of the eccentric distance of the optical disc, the eccentric distance ratio table in FIG. 8 may be adapted into an eccentric distance ratio curve shown in FIG. 9 that is to be stored in the optical disc for future use. According to a ratio P between the minimum and maximum amplitudes of the TE signal of the optical disc under test, an eccentric distance M may be determined from the eccentric distance ratio curve.

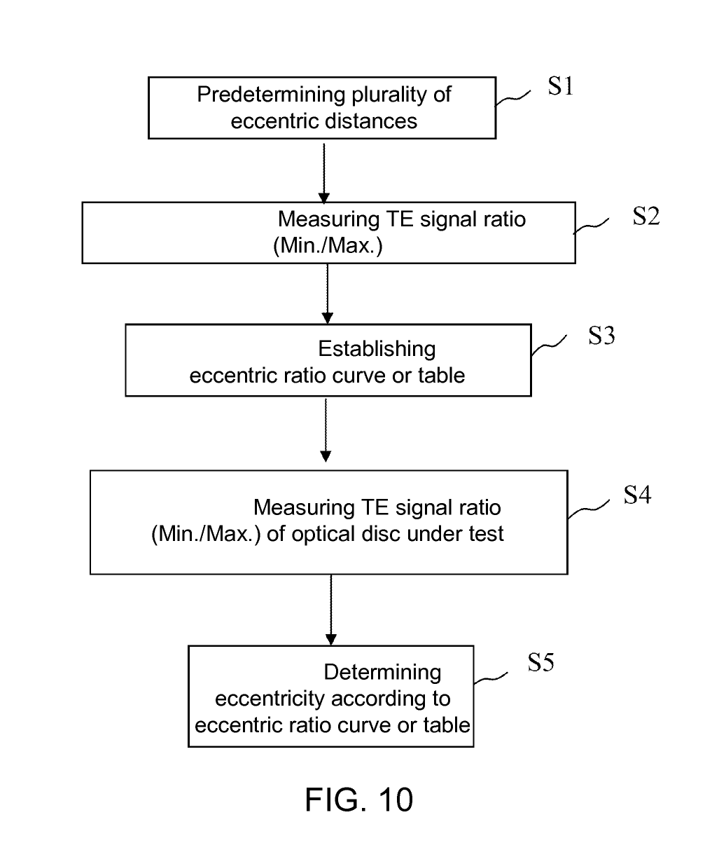

FIG. 10 shows a flowchart of a method for determining an eccentricity of an optical disc. The method for determining an eccentric distance of an optical disc by first establishing an eccentric distance ratio curve comprises steps to be described in detail below. Step S1 comprises placing and rotating a plurality of predetermined optical discs with known eccentric distances in an optical disc drive. Step S2 comprises respectively measuring a ratio between minimum and maximum amplitudes of a TE signal of the plurality of predetermined optical discs. Step S3 comprises establishing an eccentric ratio table or curve according to the plurality of optical discs with the known eccentric distances and the ratios between the minimum and maximum amplitudes of corresponding TE signals. Step S4 comprises measuring a ratio between minimum and maximum amplitudes of a TE signal of an optical disc under test. Step S5 comprises determining an eccentric distance of the optical disc under test by comparing the measured ratio with the established eccentric ratio table or curve.

With the description above, it is illustrated that in the method for determining an eccentricity of an optical disc of the present invention, ratios between minimum and maximum amplitudes of a TE signal of a plurality of predetermined optical discs with known eccentric distances are respectively measured, and an eccentric distance table or curve is established and stored in an optical disc for future use according the eccentric distances and the measured ratios between the minimum and maximum amplitudes of the corresponding TE signals of the plurality of predetermined optical discs. Without requiring to count the number of unstable TE signals, a ratio between minimum and maximum amplitudes an optical disc under test is directly measured, and the measured ratio is compared with the readily available eccentric distance ratio table or curve stored in the optical disc drive to promptly determine the eccentric distance of the optical disc.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for determining an eccentricity of an optical disc, comprising:
predetermining a plurality of optical discs with known eccentric distances;
measuring a ratio between minimum and maximum amplitudes of a track error (TE) signal of the optical disc with the known eccentric distances, respectively;
establishing an eccentric distance ratio table according to the known eccentric distances and the ratios between the minimum and maximum amplitudes of the corresponding TE signals of the optical discs;
measuring a ratio between minimum and maximum amplitudes of a TE signal of an optical disc under test; and
comparing and determining an eccentric distance of the optical disc under test according to the established eccentric distance ratio table.

2. The method according to claim 1, wherein the TE signal is a differential push-pull signal.

3. The method according to claim 1, wherein the ratios between the minimum and maximum amplitudes of the TE signals in the eccentric distance ratio table are a percentage.

4. The method according to claim 1, wherein the eccentric of the optical disc is determined through interpolation or extrapolation according to the eccentric distance ratio table.

5. The method according to claim 1, wherein the eccentric distance is an eccentric distance ratio curve adapted from the eccentric distance ratio table to determine the eccentric distances of the optical disc under test.
